(19) United States
(12) Patent Application Publication
(10) Pub. No.: US 2025/0343261 A1
(43) Pub. Date: Nov. 6, 2025

(54) SOLID ELECTROLYTE LAYER, MANUFACTURING METHOD THEREOF, AND SOLID-STATE BATTERY

(71) Applicant: TOYOTA JIDOSHA KABUSHIKI KAISHA, Toyota-shi (JP)

(72) Inventors: Masashi CHIHARA, Nagoya-shi (JP); Yuji YAMASHITA, Toyota-shi (JP); Kenichi KAKISHITA, Nagoya-shi (JP); Takahiro TABUCHI, Toyota-shi (JP)

(73) Assignee: TOYOTA JIDOSHA KABUSHIKI KAISHA, Toyota-shi (JP)

(21) Appl. No.: 19/095,298

(22) Filed: Mar. 31, 2025

(30) Foreign Application Priority Data
May 1, 2024 (JP) 2024-074497

(51) Int. Cl. H01M 10/0562

(52) U.S. Cl. CPC H01M 10/0562; H01M 2300/0068

(57) ABSTRACT

The present disclosure provides a solid electrolyte layer, a manufacturing method thereof, and a solid-state battery capable of suppressing an increase in resistance. A method for manufacturing a solid electrolyte layer 30, comprising: providing a slurry containing a solid electrolyte 20, a binder, and a dispersion medium, coating the slurry onto a support 10 having pores 12, and drying the support 10 coated with the slurry to remove the dispersion medium, wherein, in the coating of the slurry, the coating is performed such that, after drying, the thickness of the solid electrolyte 20 is 1.1 times or more and 3.3 times or less the thickness of the support, the solid electrolyte layer 30 obtained by this method, and the solid-state battery containing the solid electrolyte layer 30.

### FIELD

The present disclosure relates to a solid electrolyte layer, a manufacturing method thereof and a solid-state battery.

### BACKGROUND

The solid electrolyte layer has a function of conducting lithium ions and a function as a separator for preventing a short circuit between the negative electrode active material layer and the positive electrode active material layer. The separator is preferably formed as thin as possible to improve energy density, but it is difficult to make a thin film of solid electrolyte self-supporting. Therefore, solid electrolyte layers provided with a support have been studied.

For example, PTL 1 discloses a nonwoven fabric and a sheet containing a solid electrolyte on the surface and inside of the nonwoven fabric, wherein the weight of the nonwoven fabric per square meter is 8 g or less, and the thickness of the nonwoven fabric is 10 μm or more and 25 μm or less.

PTL 2 discloses a method for manufacturing a solid electrolyte layer used in an all-solid-state battery, comprising: a preparation step of preparing a slurry containing a solid electrolyte, a binder, and a dispersion medium; a placement step of placing a support having a hole on a first release film; a coating step of coating the slurry on the support to impregnate the support with the slurry; a drying step of drying the support coated with the slurry to remove the dispersion medium; and a pressing step of placing a second release film on a surface opposite to the first release film, on the support after drying, and pressing the first release film, the support, and the second release film in the lamination direction.

### CITATION LIST

### Patent Literature

[PTL 1] Japanese Unexamined Patent Publication No. 2016-31789
[PTL 2] Japanese Unexamined Patent Publication No. 2023-90080

### SUMMARY

### Technical Problem

A problem with any of the solid electrolyte layers disclosed in PTL 1 and 2 was that their resistance could increase.

It is an objective of the present disclosure to provide a solid electrolyte layer, a manufacturing method thereof, and a solid-state battery capable of suppressing an increase in resistance.

### Solution to Problem

The present disclosure achieves the above objective by the following means.

### <Aspect 1>

A method for manufacturing a solid electrolyte layer, comprising:
providing a slurry containing a solid electrolyte, a binder, and a dispersion medium,
coating the slurry onto a support having pores, and
drying the support coated with the slurry to remove the dispersion medium,
wherein, in the coating of the slurry, the coating is performed such that, after drying, the thickness of the solid electrolyte is 1.1 times or more and 3.3 times or less the thickness of the support.

### <Aspect 2>

The method for manufacturing a solid electrolyte layer according to Aspect 1, wherein the density of the slurry is 0.85 times or more and 1.15 times or less the density of the support.

### <Aspect 3>

A solid electrolyte layer, comprising:
a support having pores, and
a solid electrolyte present on the surface and inside of the support,
wherein the thickness of the solid electrolyte is 1.1 times or more and 3.3 times or less the thickness of the support.

### <Aspect 4>

A solid-state battery comprising the solid electrolyte layer according to Aspect 3.

### Advantageous Effects of Invention

According to the present disclosure, by setting the thickness of the solid electrolyte layer to a predetermined range of magnification relative to the thickness of the support, it is possible to provide a solid electrolyte layer, a manufacturing method thereof, and a solid-state battery capable of suppressing an increase in resistance by preventing the exposure of the support.

### BRIEF DESCRIPTION OF DRAWINGS

FIG. 1 is a cross-sectional schematic view showing an example of a solid electrolyte layer obtained by the method for manufacturing a solid electrolyte layer of the present disclosure.

FIG. 2 is an explanatory view showing an example of a method of squeezing a support coated with a slurry;

FIG. 3 is a cross-sectional schematic view showing an example of a solid-state battery comprising the solid electrolyte layer of the present disclosure.

### DESCRIPTION OF EMBODIMENTS

The embodiment of the disclosure will be described in detail below. The present disclosure is not limited to the following embodiments, and can be implemented in various ways within the scope of the argument of the present disclosure. In addition, in the description of the drawings, the same reference numerals are assigned to the same elements, and overlapping explanations are omitted.

With respect to the present disclosure, the term “solid-state battery” means a battery using at least a solid electrolyte as an electrolyte. Therefore, a solid-state battery may use a combination of a solid electrolyte and a liquid electrolyte as the electrolyte. In the present disclosure, the solid-state battery may also be an all-solid-state battery, meaning a battery that uses only a solid electrolyte as the electrolyte.

### <<Method for Manufacturing Solid Electrolyte Layer>>

A method for manufacturing a solid electrolyte layer of the present disclosure, comprising:
providing a slurry containing a solid electrolyte, a binder, and a dispersion medium,
coating the slurry onto a support having pores, and
drying the support coated with the slurry to remove the dispersion medium,
wherein, in the coating of the slurry, the coating is performed such that, after drying, the thickness of the solid electrolyte is 1.1 times or more and 3.3 times or less the thickness of the support.

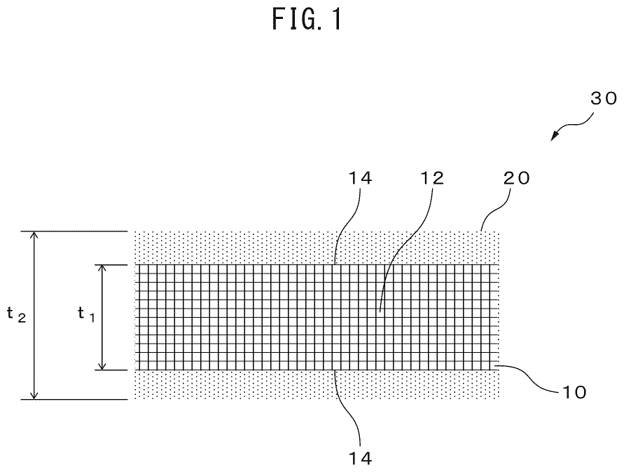

The solid electrolyte layer obtained by a method for manufacturing a solid electrolyte layer of the present disclosure (hereinafter, sometimes referred to as “the manufacturing method of the present disclosure”) has a cross-sectional structure as shown in FIG. 1. FIG. 1 is a cross-sectional schematic view showing an example of a solid electrolyte layer obtained by the method for manufacturing a solid electrolyte layer of the present disclosure. The solid electrolyte layer 30 comprises a support 10 having pores 12, and a solid electrolyte 20 present on the surface 14 and inside of the support 10.

In the manufacturing method of the present disclosure, during the coating of the slurry, the coating is performed so that, after drying the slurry, the thickness t₂ of the solid electrolyte 20 is 1.1 times or more and 3.3 times or less the thickness t₁ of the support 10, as shown in FIG. 1.

Without being bound by theory, due to the thickness t₂ of the solid electrolyte 20 is not excessively thick relative to the thickness t₁ of the support 10, the solid electrolyte 20 is sufficiently supported by the support 10. Therefore, cracks are less likely to occur in the solid electrolyte 20, and as a result, it is possible to suppress the support 10 from being exposed on the surface of the solid electrolyte layer 30.

Due to the thickness t₂ of the solid electrolyte 20 is not excessively thin relative to the thickness t₁ of the support 10, the support 10 can be sufficiently coated with the solid electrolyte 20. As a result, it is possible to suppress the support 10 from being exposed on the surface of the solid electrolyte layer 30

Generally, since the support 10 is made of insulated material, the resistance of the solid electrolyte layer 30 increases when the support 10 is exposed on the surface of the solid electrolyte layer 30. Based on this, it is possible to suppress an increase in the resistance of the solid electrolyte layer 30 by suppressing the support 10 from being exposed on the surface of the solid electrolyte layer 30

Generally, when the support 10 swells due to a binder and a dispersion medium in the slurry during the coating of the slurry, the expanded form of the support 10 is maintained even after drying the support coated with the slurry to remove the dispersion medium.

Conventionally, since the expansion of the support 10 has not been considered, it is believed that ensuring the solid electrolyte 20 was sufficiently supported by the support 10 to prevent caracks in the solid electrolyte 20, or sufficiently coating the support 10 with the solid electrolyte 20, was not properly implemented.

The manufacturing method of the present disclosure comprises slurry provision, slurry coating, and dispersion medium removal. These are explained below.

### <Slurry Provision>

A slurry containing a solid electrolyte, a binder, and a dispersion medium is provided. In addition to the solid electrolyte, the binder, and the dispersion medium, the slurry may optionally contain, for example, a conductive aid. The slurry may be commercially purchased or prepared independently. When preparing the slurry independently, examples of a method for preparing a slurry include a method of kneading a composition containing a solid electrolyte, a binder, and a dispersion medium. Examples of kneading methods include a method using a general kneading devices such as a dissolvers, a homo-mixer, kneaders, roll mills, sand mills, attritors, ball mills, vibratory mills, high-speed impeller mills, ultrasonic homogenizers, and shakers. Each of the solid electrolyte, the binder, the dispersion medium, and the conductive aid will be described later.

The density of the slurry relative to the density of the support is preferably 0.85 times or more, 0.88 times or more, 0.90 times or more, 0.92 times or more, 0.94 times or more, or 0.96 times or more, and preferably 1.15 times or less, 1.12 times or less, 1.00 times or less, or 0.98 times or less. Thus, the solid electrolyte remains inside the support during the slurry coating and dispersion medium removal stages, allowing the solid electrolyte to adhere as uniformly as possible to both surfaces of the support.

### <Slurry Coating>

A slurry is coated onto a support that has pores. The support is impregnated with the slurry by coating the slurry onto the support. Thus, it is possible to remain the slurry on the surface of the support while filling the slurry into the pores of the support. The method for coating is not particularly limited, but examples thereof include dipping method, doctor blade method, die coating method, gravure coating method, spray coating method, electrostatic coating method, and bar coating method.

In slurry coating, the coating is performed so that, after drying the slurry, the thickness of the solid electrolyte is 1.1 times or more and 3.3 times or less the thickness of the support. When the thickness of the solid electrolyte is 1.1 times or more the thickness of the support, the support can be sufficiently coated with the solid electrolyte. From this perspective, the thickness of the solid electrolyte may be 1.2 times or more, 1.3 times or more, 1.4 times or more, 1.5 times or more, or 1.6 times or more the thickness of the support. When the thickness of the solid electrolyte is 3.3 times or less the thickness of the support, the solid electrolyte can be sufficiently supported by the support, and cracks are less likely to occur in the solid electrolyte. From this perspective, the thickness of the solid electrolyte may be 3.0 times or less, 2.7 times or less, 2.6 times or less, 2.5 times or less, 2.4 times or less, 2.3 times or less, 2.2 times or less, 2.1 times or less, or 2.0 times or less the thickness of the support.

As described above, generally, the support swells due to the coating of the slurry, and after removing the dispersion medium, the expanded form of the support is maintained. Since the degree of expansion of the support is relatively stable, the slurry may be coated onto the support in anticipation of expansion of the support.

In order to reliable ensure that the thickness of the solid electrolyte and the thickness of the support fall within the range described above, it is preferable to sandwich the support coated with the slurry between opposing members and squeeze the support coated with the slurry.

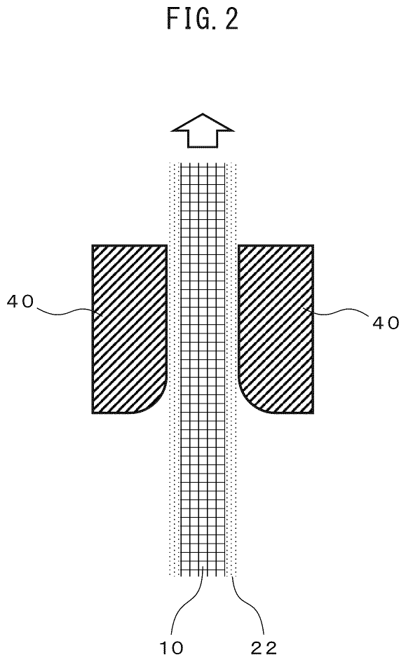

FIG. 2 is an explanatory view showing an example of a method for squeezing the support coated with the slurry. The support 10 coated with slurry 22 is sandwiched between opposing members 40, and the support 10 coated with slurry 22 is pulled up in the direction of the arrow to perform squeezing. The separation distance of the opposing members 40 may be the same as t₂ in FIG. 1. That is, the separation distance of the opposing members 40 may be the same as the thickness of the solid electrolyte 20 after drying (after removal of the dispersion medium).

### <Dispersion Medium Removal>

The support coated with the slurry is dried to remove the dispersion medium. The drying method is not particularly limited, as long as the dispersion medium can be removed, and examples thereof include well-known methods such as warm air and/or hot air drying, infrared drying, reduced-pressure drying, and dielectric heating drying. Examples of the drying atmosphere include an inert gas atmosphere such as an argon gas atmosphere and/or a nitrogen gas atmosphere, an air atmosphere, and a vacuum atmosphere.

The drying temperature is not particularly limited, but it is preferably a temperature at which the solid electrolyte does not deteriorate. The drying temperature may be, for example, 100° C. or more, 120° C. or higher, or 130° C. or higher, and may be 200° C. or lower, 180° C. or lower, or 160° C. or lower. The drying time is not particularly limited, and can be appropriately adjusted.

### <<Solid Electrolyte Layer>>

A solid electrolyte layer of the present disclosure, comprising:
a support having pores, and
a solid electrolyte present on the surface and inside of the support,
wherein the thickness of the solid electrolyte is 1.1 times or more and 3.3 times or less the thickness of the support.

The structure of the solid electrolyte layer can be referred to in the already explained FIG. 1 and the description of <<Method for manufacturing solid electrolyte layer>>.

### <Solid-State Battery>

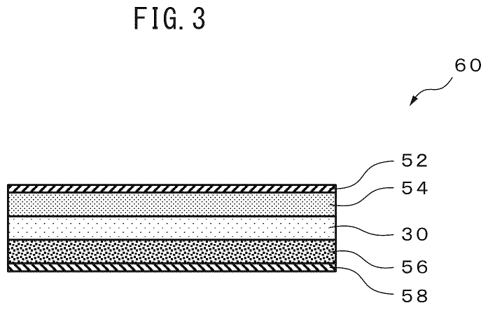

FIG. 3 is a cross-sectional schematic view showing an example of a solid-state battery comprising the solid electrolyte layer of the present disclosure. In the solid-state battery 60, the negative electrode current collector layer 52, the negative electrode active material layer 54, the solid electrolyte layer 30, the positive electrode active material layer 56, and the positive electrode current collector layer 58 are laminated in this order. Regarding the solid electrolyte layer 30, the description of the support 10 is omitted. The negative electrode current collector layer 52, the negative electrode active material layer 54, the positive electrode active material layer 56, and the positive electrode current collector layer 58 may be in a known embodiments, but an outline will be described later. Each layer is laminated using known methods.

### <<Each Composition of Solid Electrolyte Layer, Manufacturing Method Thereof, and Solid-State Battery>>

Hereinafter, each composition of the solid electrolyte layer, the manufacturing method thereof, and the solid-state battery of the present disclosure will be described.

### <Solid Electrolyte>

The material of the solid electrolyte is not particularly limited, and may be, for example, a sulfide solid electrolyte, an oxide solid electrolyte, or a polymer electrolyte.

Examples of the sulfide solid electrolyte include a sulfide-based amorphous solid electrolyte, a sulfide-based crystalline solid electrolyte, or an aldilodite-type solid electrolyte, but are not limited thereto. Specific examples of sulfide solid electrolytes include, Li₂S—P₂S₅-based (such as Li₇P₃S₁₁, Li₃PS₄, Li₈P₂S₉), Li₂S—SiS₂, LiI—Li₂S—SiS₂, LiI—Li₂S—P₂S₅, LiI—LiBr—Li₂S—P₂S₅, Li₂S—P₂S₅—GeS₂ (such as Li₁₃GeP₃S₁₆, Li₁₀GeP₂S₁₂), LiI—Li₂S—P₂O₅, LiI—Li₃PO₄—P₂S₅, Li₇₋ₓPS₆₋ₓClₓ; or combinations thereof, but are not limited thereto.

Examples of the oxide solid electrolyte include, Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ (PO₄)₃, Li₁₊ₓAlₓGe₂₋ₓ (PO₄)₃, Li₃PO₄, or Li₃₊ₓPO₄₋ₓNₓ(LiPON); or combinations thereof, but are not limited thereto.

The sulfide solid electrolyte and the oxide solid electrolyte may be glass or crystallized glass (glass ceramics).

Examples of the polymer electrolyte include polyethylene oxide (PEO), polypropylene oxide (PPO), and copolymers thereof, but are not limited thereto.

The ratio of the solid electrolyte in the solid content of the slurry may be, for example, 70% by mass or more and 99% by mass or less. Examples of the shape of the solid electrolyte include particulate form. The particle size (D50) of the solid electrolyte may be, for example, 10 nm or more, and 50 μm or less. The D50 value can be calculated, for example, based on measurements obtained from laser diffractometer particle size analyzers or scanning-electron microscopes (SEM). It is preferable that the ionic conductivity of the solid electrolyte at 25° C. be high. The ionic conductivity of the solid electrolyte at 25° C. may be, for example, 1×10⁻⁴ S/cm or more, or 1×10⁻³ S/cm or more.

### <Binder>

The binder is not particularly limited. The binder may be, for example, materials such as polyvinylidene fluoride (PVdF), butadiene rubber (BR), polytetrafluoroethylene (PTFE), and styrene butadiene rubber (SBR), but are not limited thereto. The binder is not particularly limited, but only one kind thereof may be used alone, and two or more kinds thereof may be used in combination.

### <Dispersion Medium>

Examples of the dispersion medium include esters such as butyl butyrate, dibutyl ether, and ethyl acetate; ketones such as diisobutyl ketone (DIBK), methyl ketone, and methyl propyl ketone; aromatic hydrocarbons such as xylene, benzene, and toluene; alkanes such as heptane, dimethylbutane, and methylhexane; and amines such as tributylamine and allylamine. Regarding the ratio of the dispersion medium in the slurry, for example, the solid content in the slurry is set to be 30% by mass or more and 50% by mass or less.

### <Conductive Aid>

The conductive aid is not particularly limited. Conductive aid may be, for example, vapor grown carbon fiber (VGCF), acetylene black (AB), ketchen black (KB), carbon nanotubes (CNT), or carbon nanofibers (CNF), but is not limited thereto. The forms of the conductive aid may be, for example, particulate or fibrous, and the size thereof is not particularly limited. The conductive aid is not particularly limited, but only one kind thereof may be used alone, and two or more kinds thereof may be used in combination.

### <Negative Electrode Current Collector Layer>

The materials used for the negative electrode current collector layer is not particularly limited, but commonly used materials for the negative electrode current collector in batteries can be appropriately adopted. Examples of materials used for the negative electrode current collector layer include Cu, Ni, Cr, Au, Pt, Ag, Al, Fe, Ti, Zn, Co, stainless-steel, and carbon sheets, but are not limited thereto. The negative electrode current collector layer may have some coating layer on its surface for the purpose of adjusting resistance.

### <Negative Electrode Active Material Layer>

The negative electrode active material layer includes at least a negative electrode active material, and may optionally further include a solid electrolyte, a conductive aid, and a binder. The negative electrode active material layer may comprise various other additives. The content of each component, such as the negative electrode active material, the solid electrolyte, the conductive aid, and the binder in the negative electrode active material layer may be appropriately determined according to the desired battery performance.

As the negative electrode active material, various materials having a potential for absorbing and releasing lithium ions (charge and discharge potential) which is lower than that of the positive electrode active material described later may be employed. The materials for the negative electrode active material is not particularly limited, and may be metal lithium, and may be a material capable of absorbing and releasing metal ions such as lithium ions. Examples of materials capable of absorbing and releasing metal ions such as lithium ions may include, but are not limited to, alloy-based negative electrode active materials, carbon materials, or lithium titanate (Li₄Ti₅O₁₂).

Alloy-based negative electrode active material is not particularly limited, and may include, for example, Si alloy-based negative electrode active materials or Sn alloy-based negative electrode active materials. Si alloy-based negative electrode active materials include silicon, silicon oxides, silicon carbides, silicon nitrides, or solid solutions thereof. Further, Si alloy-based negative electrode active material may include a metal elements other than silicon, such as Fe, Co, Sb, Bi, Pb, Ni, Cu, Zn, Ge, In, Sn, and Ti. Sn alloy-based negative electrode active materials include tin, tin oxides, tin nitrides, or solid solutions thereof. Further, Sn alloy-based negative electrode active materials may include metal elements other than tin, such as Fe, Co, Sb, Bi, Pb, Ni, Cu, Zn, Ge, In, Ti, and Si.

The carbon material is not particularly limited, and examples thereof include hard carbon, soft carbon, and graphite.

### <Positive Electrode Active Material Layer>

The positive electrode active material layer includes at least a positive electrode active material, and may optionally further include a solid electrolyte, a conductive aid, and a binder. The positive electrode active material layer may comprise various other additives. The content of each component, such as the positive electrode active material, the solid electrolyte, the conductive aid, and the binder in the positive electrode active material layer may be appropriately determined according to the desired battery performance.

The material of the positive electrode active material is not particularly limited, as long as it is possible to absorb and release lithium ions. As the positive active material may be, for example, lithium cobalt oxide (LiCoO₂), lithium nickel oxide (LiNiO₂), lithium manganese oxide (LiMn₂O₄), lithium nickel-cobalt-manganese oxide (NCM:LiCO_{1/3}Ni_{1/3}Mn_{1/3}O₂), lithium nickel-cobalt-aluminum oxide (LiNi_{0.8}(CoAl)_{0.2}O₂), or heteroelement-substituted Li—Mn spinel represented by the composition Li₁₊ₓMn_{2-x-y}M_{y}O₄ (where M is one or more metal elements selected from Al, Mg, Co, Fe, Ni, and Zn), but is not limited thereto.

The positive electrode active material is not particularly limited, but may have a coating layer. The coating layer is a layer comprising a substance which has lithium ion conductivity, has low reactivity with the positive electrode active material or the solid electrolyte, and can maintain the form of the coating layer without flowing even when in contact with the active material or solid electrolyte. Specific examples of materials constituting the coating layer include LiNbO₃, as well as Li₄Ti₅O₁₂, Li₃PO₄, but are not limited thereto.

The solid electrolyte, the conductive aid, and the binder which can be included in the positive electrode active material layer can be referred to in the description of the above “<negative electrode active material layer>”

### <Positive Electrode Current Collector Layer>

The materials used for the positive electrode current collector layer is not particularly limited, but commonly used materials for the positive electrode current collector in batteries can be appropriately adopted. Examples of materials used for the positive electrode current collector layer include Cu, Ni, Cr, Au, Pt, Ag, Al, Fe, Ti, Zn, Co, and stainless-steel, but are not limited thereto. The positive electrode current collector layer may have some coating layer on its surface for the purpose of adjusting resistance, etc. Also, the positive electrode current collector layer may be a metal foil or a substrate on which the above-mentioned metal is plated or deposited.

### EXAMPLES

### <<Preparation of Samples>>

Each sample was prepared according to the following procedures.

The sulfide solid electrolyte was weighed so that it accounted for 99% by mass, and the styrene-butadiene rubber (SBR)-based binder was weighed so that it accounted for 1% by mass. These were then added to a dispersion medium so that the solid content was 30% by mass or more and 50% by mass or less, ultrasonic dispersion treatment was performed using an ultrasonic dispersion device for one minutes. Thus, a slurry for the solid electrolyte layer was obtained.

After the nonwoven fabric as a support was immersed in the slurry, the nonwoven fabric to which the slurry was adhered was squeezed using the member 40 shown in FIG. 3 thereby coating the nonwoven fabric with the slurry. The basis weight, including the nonwoven fabric, was 1 mg/cm³ or more and 10 mg/cm³ or less.

The squeezed nonwoven fabric was dried in a suspended state to obtain a sample.

### <<Evaluation>>

The surface of each sample was observed using a laser microscope, and the presence or absence of exposure of the nonwoven fabric on the surface of the solid electrolyte layer was confirmed. For samples of Examples 1 to 4, the cross-section of each sample were observed using a microscope, and the thickness tib of the nonwoven fabric after drying was measured.

For all samples from Examples 1 to 4, in which the magnification of the thickness t₂ of the solid electrolyte relative to the thickness tib of the support (nonwoven) after drying was within the specified range, it was confirmed that there was no exposure of the nonwoven fabric on the surface of the solid electrolyte layer.

On the other hand, in the sample of Comparative Example 1, the solid electrolyte was not sufficiently supported by the support, resulting cracks on the surface of the solid electrolyte layer, leading to the exposure of the nonwoven fabric. In the sample of Comparative Example 2, the support was not sufficiently coated with the solid electrolyte, and leading to the exposure of the nonwoven fabric.

For the samples of Comparative Examples 1 and 2, instead of determining the magnification (t₂/t_{1b}) of the thickness t₂ of the solid electrolyte relative to the thickness tib of the support (non-woven fabric) after drying, the magnification (t₂/t₁ₐ) of the thickness t₂ of the solid electrolyte relative to the thickness t₁ₐ support (non-woven) before coating was calculated. In the sample of Examples 1 to 4, the maximum magnification of the thickness tib of the support (nonwoven fabric) after drying relative to the thickness t₁ₐ of the support (nonwoven fabric) before coating was 1.278 times. Using this value, the t₂/t_{1b} values were converted from t₂/t₁ₐ of Comparative Examples 1 and 2, resulting in, respectively, 5.20 and 0.98. Based on these converted values, it can be understood that in the sample of Comparative Example 1, the t₂/t_{1b} value exceeded the upper limit for the solid electrolyte layer of the present disclosure, and in the sample of Comparative Example 2, the t₂/t_{1b} did not meet the lower limit for the solid electrolyte layer of the present disclosure.

From these findings, the effects of the solid electrolyte layer and the manufacturing method thereof of the present disclosure have been confirmed. Based on this, it is suggested that the solid-state battery including the solid electrolyte layer of the present disclosure exhibits a desired effects.

TABLE 1

| | | Thickness | | | | | |
|---|---|---|---|---|---|---|---|
| | Density | | Nonwoven | Nonwoven | Thickness | Thickness | |
| | ratio | Solid | fabric before | fabric after | ratio | ratio | Exposure of |
| | Slurry/ | electrolyte | coating | drying | t₂/t₁ₐ | t₂/t_{1b} | nonwoven |
| | Support | t₂ [μm] | t₁ₐ [μm] | t_{1b} [μm] | [—] | [—] | fabric |
| Example 1 | 1.12 | 29.0 | 15.0 | 18.0 | 1.93 | 1.61 | No |
| Example 2 | 0.96 | 58.0 | 18.0 | 32.0 | 3.22 | 2.64 | No |
| Example 3 | 0.96 | 63.0 | 18.0 | 23.0 | 3.50 | 2.74 | No |
| Example 4 | 0.96 | 46.0 | 18.0 | 23.0 | 2.56 | 2.00 | No |
| Comparative Example 1 | 0.88 | 99.6 | 15.0 | — | 6.64 | — | Yes |
| Comparative Example 2 | 1.12 | 18.7 | 15.0 | — | 1.25 | — | Yes |

### REFERENCE SIGNS LIST

10 Support
12 Pore
14 Surface
20 Solid electrolyte
22 Slurry
30 Solid electrolyte layer
40 Member
52 Negative electrode current collector layer
54 Negative electrode active material layer
56 Positive electrode active material layer
58 Positive electrode current collector layer

1. A method for manufacturing a solid electrolyte layer, comprising:
providing a slurry containing a solid electrolyte, a binder, and a dispersion medium,
coating the slurry onto a support having pores, and
drying the support coated with the slurry to remove the dispersion medium,
wherein, in the coating of the slurry, the coating is performed such that, after drying, the thickness of the solid electrolyte is 1.1 times or more and 3.3 times or less the thickness of the support.

2. The method for manufacturing a solid electrolyte layer according to claim 1, wherein the density of the slurry is 0.85 times or more and 1.15 times or less the density of the support.

3. A solid electrolyte layer, comprising:
a support having pores, and
a solid electrolyte present on the surface and inside of the support,
wherein the thickness of the solid electrolyte is 1.1 times or more and 3.3 times or less the thickness of the support.

4. A solid-state battery comprising the solid electrolyte layer according to claim 3.
